(19) United States
(12) Patent Application Publication
(10) Pub. No.: US 2021/0373669 A1
(43) Pub. Date: Dec. 2, 2021

(54) MULTI-MODAL HAPTICS FEEDBACK GLOVE

(71) Applicant: BEIHANG UNIVERSITY, Beijing (CN)

(72) Inventors: Dangxiao WANG, Beijing (CN); Yu ZHANG, Beijing (CN); Ziqi WANG, Beijing (CN); Yuru ZHANG, Beijing (CN)

(21) Appl. No.: 17/285,912

(22) PCT Filed: Apr. 18, 2019
(86) PCT No.: PCT/CN2019/083162

§ 371 Date: Apr. 16, 2021

(30) Foreign Application Priority Data
Oct. 23, 2018 (CN) 201811237961.9

(51) Int. Cl. G06F 3/01

(52) U.S. Cl. CPC G06F 3/016; G06F 3/014

(57) ABSTRACT

A multimodal tactile feedback glove, comprising a finger position tracking unit, which is used for measuring a spacial position of fingers; a movement angle measurement device, which is used for measuring a movement angle of each joint of fingers; a fingertip force feedback unit (1), which is arranged on a back side of a hand for providing the fingertip force feedback by a fingertip drive; a joint force feedback unit (2), which is arranged at the joints of fingers and for providing the joint force feedback by a variable stiffness joint drive; and a fingertip tactile feedback unit (3), which is selected from one of a temperature feedback unit, a texture feedback unit or a temperature-texture combined feedback unit, is arranged at a position on one side of the palm where the fingertip feedback unit (1) is connected with the fingertip, and is used for providing temperature feedback or texture feedback or simultaneous temperature and texture feedback of the fingertip. The force feedback from the feedback glove can simultaneously provide force feedback of two grasping modes: hand grip and pinch; The multimodal tactile fusion feedback including stiffness feedback, temperature feedback and texture feedback allows a user to have a rich multimodal tactile fusion feedback experience.

### CROSS-REFERENCE TO RELATED APPLICATIONS

The present application claims priority from Chinese patent application No. 201811237961.9 filed with the Chinese National Intellectual Property Administration on Oct. 23, 2018 and entitled “Multi-modal Haptics Feedback Glove”, the entire content of which is incorporated herein by reference.

### FIELD OF THE INVENTION

The present application relates to a haptics feedback device, in particular to a multi-modal haptics feedback glove.

### BACKGROUND OF THE INVENTION

At present, what most haptic devices can achieve is single-modal feedback, such as stiffness (force) feedback, texture feedback, temperature feedback, and so on. Some scholars have also done research on multi-modal haptics feedback, in which two to three properties are integrated together, such as integration of stiffness and shape, and integration of temperature and stiffness. On a wearable haptic apparatus, there are fewer devices that can perform multi-modal haptics feedback. In particular, most feedback gloves can only simulate a gripping force and measure a movement position of finger, and cannot simulate temperature feedback. At the same time, as shown in FIG. 1, a human hand has two grabbing modes: gripping and pinching. When the human hand is pinching an object, only fingertips of the fingers are stressed, and when the human hand is gripping an object, all parts of the fingers are stressed. Current force feedback gloves can only perform force feedback of the fingertip or can only perform force feedback of all parts. Hitherto, there is no force feedback glove that can satisfy the two grabbing modes at the same time.

### SUMMARY OF THE INVENTION

An object of the present disclosure is to overcome the defects in the prior art and provide a multi-modal haptics feedback glove, which not only can perform stiffness, temperature and texture feedbacks, but also can simultaneously satisfy force feedback of two grabbing modes of gripping and pinching through stiffness (force) feedback.

The following technical solution is provided by the present disclosure: a multi-modal haptics feedback glove, including: finger position tracking units for measuring positions of fingers in space; movement angle measuring devices for measuring movement angles of individual joints of the fingers; fingertip force feedback units disposed on a back side of a hand, a fingertip force feedback being provided by fingertip actuators; joint force feedback units disposed at the joints of the fingers, a joint force feedback being provided by variable-stiffness joint actuators; and fingertip haptics feedback units, which are selected from one of a temperature feedback unit, a texture feedback unit or a temperature-texture combined feedback unit, are disposed on a palm side at positions where the fingertip force feedback units are connected to the fingertips, and are configured to provide temperature feedback or texture feedback or simultaneous feedbacks of both temperature and texture of the fingertips.

Further, the joint actuator includes a variable-stiffness sealing structure and an air pipe communicating with an interior of the variable-stiffness sealing structure; the variable-stiffness sealing structure is inflated or deflated through the air pipe, and a stiffness of the joint actuator is controlled by controlling an air pressure inside the variable-stiffness sealing structure.

Further, the interior of the variable-stiffness sealing structure includes multiple layers of flakes, and the multiple layers of flakes are stacked together.

Further, the fingertip actuators may be soft actuators.

Further, the soft actuator can bend and generate an elastic force; one end of the soft actuator is connected to the back of the hand, and the other end of the soft actuator is connected to the fingertip of the finger through a rigid connecting rod, so as to realize transmission of force; in a free space state, within a gripping range of the fingers, a resistance generated by the bending of the soft actuator does not exceed a defined value; and in a constrained space state, the soft actuator is inflated and bent, and the force generated by the soft actuator is transmitted to the finger through the rigid connecting rod, thereby generating a feedback force.

Further, a connecting member is further provided between the rigid connecting rod and the fingertip of the finger.

Further, the fingertip haptics feedback unit is disposed on a surface of the connecting member that is in contact with the fingertip of the finger.

The present disclosure has the following advantageous effects: the stiffness (force) feedback provided by the feedback glove of the present disclosure can simultaneously satisfy the force feedback of two grabbing modes of a human hand, i.e., gripping and pinching; it can provide multi-modal haptics integrated feedback of stiffness, temperature and texture, which enables users to have a rich experience of multi-modal haptics integrated feedback. The feedback glove increases the immersion of the user's interaction with virtual reality, allows users to touch and manipulate virtual objects in an intuitive and direct way, and has a light weight and a low cost, while still being capable of providing realistic haptics feedback.

### BRIEF DESCRIPTION OF THE DRAWINGS

FIG. 1 is a schematic view of two grabbing modes of a human hand.

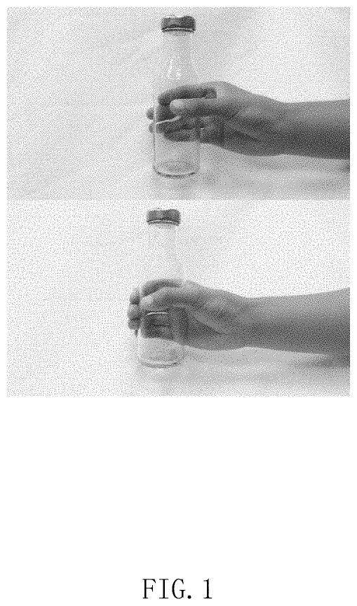

FIG. 2 is a schematic structural view of a feedback glove.

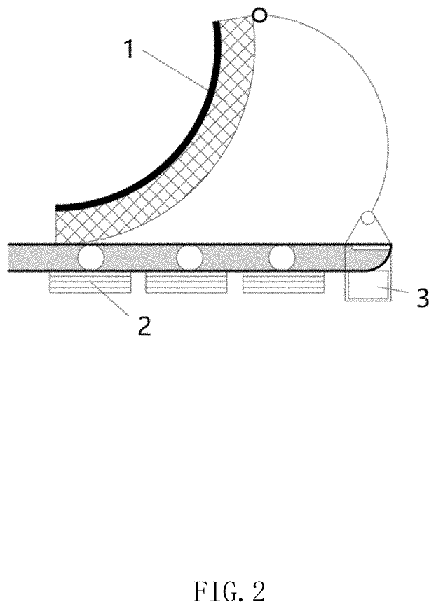

FIG. 3 is a schematic structural view of a joint actuator with an inflating/deflating structure.

FIG. 4 is a schematic view of various parameters of a control system of a joint force feedback unit.

FIG. 5 is a schematic structural view of a fingertip force feedback unit.

FIG. 6 is a schematic view of the length of a soft actuator of the fingertip force feedback unit.

FIG. 7 is a schematic view of the structure of the soft actuator of the fingertip force feedback unit.

FIG. 8 is a schematic view of a stretching state of a finger in a free space.

FIG. 9 is a schematic view of a grabbing state of a finger in a free space.

FIG. 10 is a schematic structural view of a rigid connecting rod.

FIG. 11 is a schematic structure view of a connecting member.

### DETAILED DESCRIPTION OF THE EMBODIMENT(S) OF THE INVENTION

The technical solutions of the present disclosure will be clearly and fully described below with reference to the accompanying drawings. Obviously, the described embodiments are only some of the embodiments of the present disclosure, not all of them. Based on the embodiments of the present disclosure, all other embodiments obtained by those skilled in the art without creative work shall fall within the scope of protection of the present disclosure.

It should be noted that in the description of the present disclosure, directional or positional relationships indicated by terms such as “center”, “upper”, “lower”, “left”, “right”, “vertical”, “horizontal”, “inner” and “outer” are based on the directional or positional relationships shown in the drawings. They are merely used for the convenience of simplified description of the present disclosure, and do not indicate or imply that the device or element involved must have a specific orientation, or be configured or operated in a specific orientation. Therefore, they should not be construed as limiting the present disclosure. In addition, terms “first”, “second” and “third” are used for descriptive purpose only, and should not be construed as indicating or implying relative importance.

It should be noted that in the description of the present disclosure, unless otherwise clearly specified and defined, terms “install”, “connect” and “communicate” should be understood in a broad sense; for example, the connection may be a fixed connection, or may also be a detachable connection, or an integral connection; it may be a mechanical connection, or may also be an electrical connection; it may be a direct connection, or an indirect connection implemented through an intermediate medium, or it may be an internal communication between two elements. For those skilled in the art, the specific meaning of the above terms in the present disclosure can be understood according to specific situations.

A multi-modal haptics feedback glove includes: finger position tracking units for measuring positions of fingers in space; joint movement angle measuring devices for measuring movement angles of individual joints of the fingers; fingertip force feedback units 1 disposed on a back side of a hand, a fingertip force feedback being provided by fingertip actuators; joint force feedback units 2 disposed at the joints of the fingers, a joint force feedback being provided by variable-stiffness joint actuators; and fingertip haptics feedback units 3, which are selected from one of a temperature feedback unit, a texture feedback unit or a temperature-texture combined feedback unit, are disposed on a palm side at positions where the fingertip force feedback units 1 are connected to the fingertips, and are configured to provide temperature feedback or texture feedback or simultaneous feedbacks of both temperature and texture of the fingertips.

The joint force feedback units 2 includes joint actuators, and the joint actuators can adopt an inflating/deflating structure, or a magnetorheological liquid. The stiffness of the joint actuator can be changed according to different states of simulation. When it is not required to provide a force to the finger joint, the stiffness of the variable-stiffness actuator is as small as possible, so that the finger joint is not stressed. When it is required to provide a force to the finger joint, the stiffness of the variable-stiffness actuator is as large as possible.

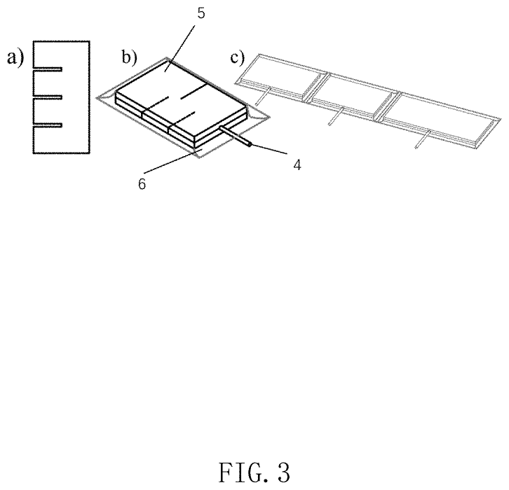

FIG. 3 is a schematic structural view of a joint actuator adopting an inflating/deflating structure. The joint actuator includes a variable-stiffness sealing structure 6 and an air pipe 4 communicating with an interior of the variable-stiffness sealing structure 6, and an interior of the variable-stiffness sealing structure 6 includes multiple flakes 5. The flakes 5 are made of fiber, or paper (including sandpaper, rough paper), etc., and the multiple flakes 5 are stacked together.

When the air pressure inside the joint actuator is the same as the outside air pressure, the joint actuator can bend freely with the rotation of the finger, providing a very small resistance torque for the finger joint. This is a simulation of a free space.

When the joint actuator is inflated, the air pressure inside the variable-stiffness sealing structure 6 is larger than the outside air pressure, and it is difficult for the variable-stiffness sealing structure 6 to bend under the action of the internal air pressure. When the finger joint tries to rotate, the joint actuator will provide a large resistance torque for the finger joint. This is a simulation of a constrained space.

When the joint actuator is deflated, the multiple flakes 5 in the variable-stiffness sealing structure 6 stick together, and there is a very large friction between each other, making the entire variable-stiffness sealing structure 6 become rigid and difficult to bend. When the finger joint tries to rotate, the joint actuator will provide a large resistance torque for the finger joint. This is another simulation of a constrained space.

For a single-layer flake 5, cracks can be cut into it to reduce its stiffness, thereby reducing the resistance brought by the free space.

The joint actuator may be disposed at the finger joint on the palm side or the back side of the hand or a side adjacent to other fingers. It either half wraps the finger joint or fully wraps the finger joint. The joint actuator should avoid interference with the fingertip force feedback unit during installation. An independent joint actuator may be disposed at each joint position, that is, a single-joint constraint mode is implemented, or a shared joint actuator may be disposed at multiple joint positions, that is, a multi joint constraint mode is implemented.

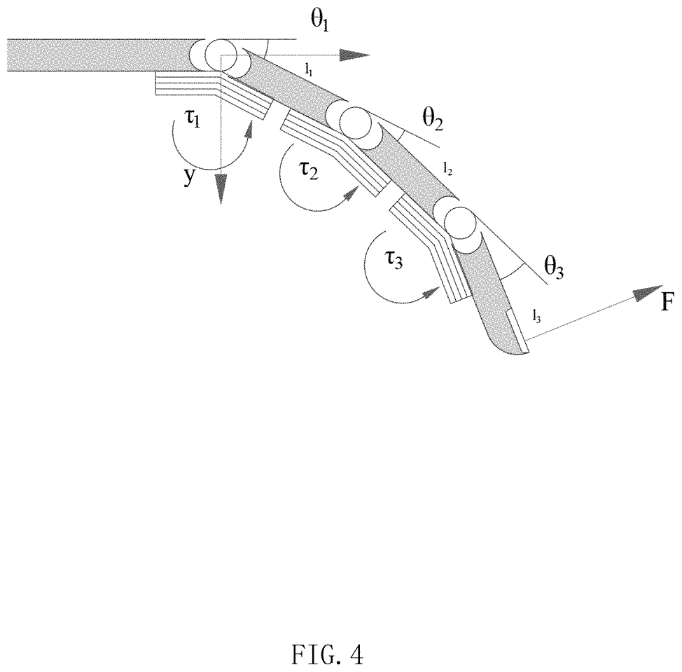

With reference to FIG. 4, a control method of the joint force feedback unit 2 is described as follows: a haptics rendering algorithm is used to set a virtual grabbing force of each fingertip, and the Jacobian matrix is used to convert the fingertip force into a resistance torque of each finger joint;

as shown in the following formula, τ is a joint torque, F is a reduced fingertip force, and J is the Jacobian matrix.

$$τ = {J}^{T} F$$

$$J ( {θ}_{1} , {θ}_{2} , {θ}_{2} ) = [ \begin{matrix}- {l}_{1} {s}_{1} - {l}_{2} {s}_{12} - {l}_{3} {s}_{123} & - {l}_{2} {s}_{12} - {l}_{3} {s}_{123} & - {l}_{3} {s}_{123} \\ {l}_{1} {c}_{1} + {l}_{2} {c}_{12} + {l}_{3} {c}_{123} & {l}_{2} {c}_{12} + {l}_{3} {c}_{123} & {l}_{3} {c}_{123}\end{matrix} ]$$

For the meaning of each letter in the formula, reference may be made to FIG. 4.

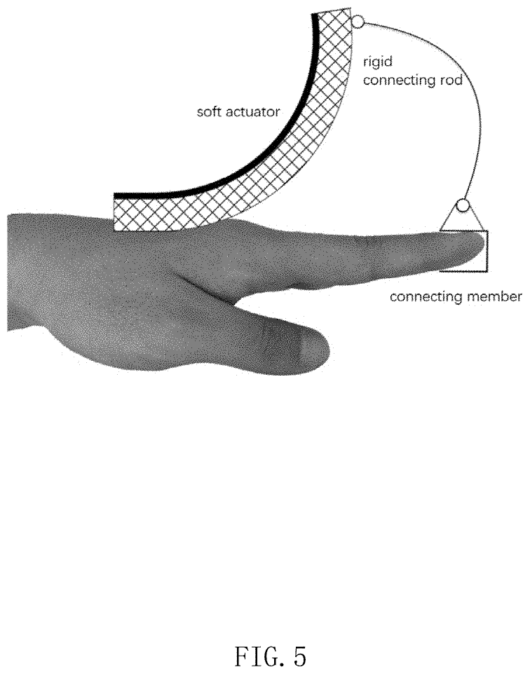

The fingertip force feedback unit 1 includes a fingertip actuator. The fingertip actuator can use a motor to provide a feedback force, or may use gas to provide a feedback force, or may also use a soft actuator to provide a feedback force. With reference to FIGS. 5-11, schematic structural views of the fingertip force feedback unit 1 adopting a soft actuator are shown.

The fingertip actuator is a soft actuator 7, which can bend and generate an elastic force; one end of the soft actuator 7 is connected to the back of the hand, and the other end of the soft actuator 7 is connected to the fingertip of the finger through a rigid connecting rod 8 so as to realize transmission of force; in a free space state, within a gripping range of the fingers, a resistance generated by the bending of the soft actuator 7 does not exceed a defined value; and in a constrained space state, the soft actuator 7 is inflated and bent, and the force generated by the soft actuator 7 is transmitted to the fingertip through the rigid connecting rod 8. Therefore, a feedback force is generated, that is, the requirements of the fingertip force feedback unit 1 in both the free space state and the constrained space state are simultaneously satisfied. A connecting member 9 is further provided between the rigid connecting rod 8 and the fingertip of the finger. Both the rigid connecting rod 8 and the connecting member 9 are formed by 3D printing of resin materials. Under the premise of guaranteeing a sufficient stiffness, the structure is lightweight and beautiful, which greatly reduces the overall quality of the glove. The entirety of the glove is sewn with a Hook & Loop (Velcro), ensuring the overall light weight and convenience of the glove.

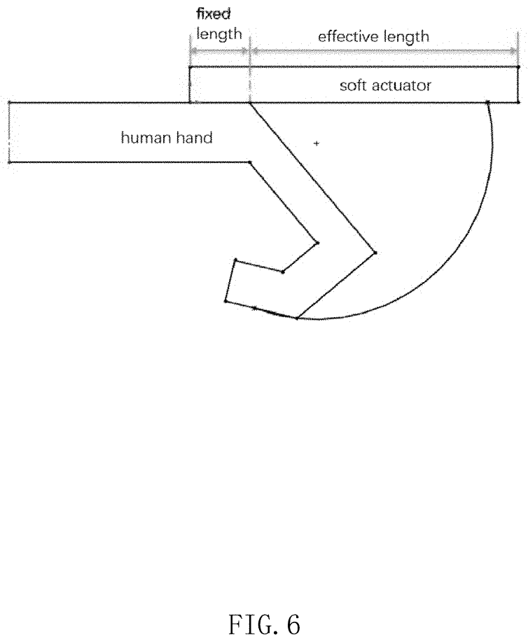

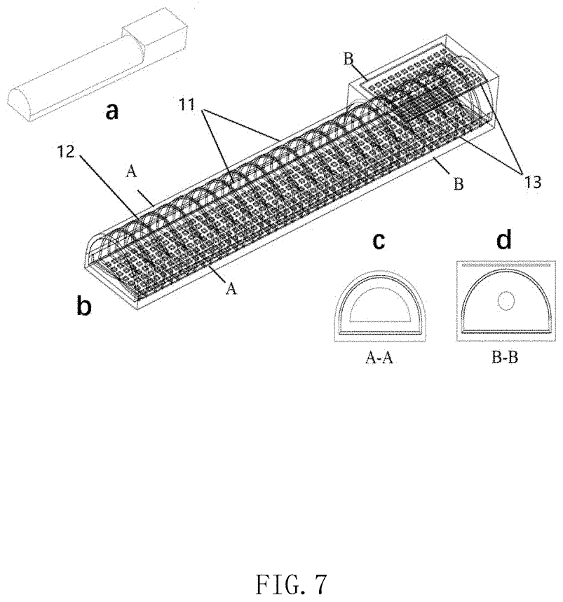

The soft actuator 7 can bend under a certain air pressure to generate a force. It was first applied in the medical rehabilitation field. However, what is required in the medical rehabilitation field is an active force, while what is required in the force feedback device is a passive force. Therefore, there is a difference between the two in principle and purpose of use, as well as in the structure. As shown in FIG. 7, the soft actuator 7 may be a filament-enhanced soft actuator. The soft actuator 7 includes a deformable layer and a non-deformable layer 13. The deformable layer is made of silica gel 11 and fiber filaments 12 and can be stretched. The non-deformable layer 13 is made of glass fiber mesh, and is not stretchable. The non-deformable layer 13 is used to limit the stretching of the soft actuator toward one side, and cooperate with the stretching of the deformable layer to realize the bending of the soft actuator 7; the fiber filaments 12 can limit the expansion of the soft actuator so as to improve the air pressure that the soft actuator can withstand and increase its output force. The filaments 12 are Kevlar fibers. One end of the soft actuator 7 is connected to the back of the hand, and the other end of the soft actuator 7 is connected to the rigid connecting rod 8. As shown in FIG. 6, a part of the soft actuator 7 that is connected to the back of the hand cannot bend, and the length of this part is a fixed length. The length of the soft actuator 7 of a part that can bend is an effective length, and the actual length of the soft actuator is equal to the effective length plus the fixed length. The longer the effective length of the soft actuator 7 is, the larger the output power will be. However, the length of the soft actuator 7 is limited by the size of the human hand and should be moderate to ensure that the volume of the glove is not too large, which would otherwise affect its portability and light weight. Therefore, it is preferable that the effective length of the soft actuator 7 is the same as the length of the finger.

The rigid connecting rod 8 is an important component of the force feedback glove, and the design of its shape and structure directly affects the use effect of the glove. In the designing process, the requirements of the force feedback glove with the soft actuator in both the free space and the constrained space are mainly considered, and the two states of palm stretching and gripping during use are considered.

In the free space state, that is, when the soft actuator is in an empty pressure state, the resistance generated by the bending of the soft actuator 7 must be small enough within the gripping range of the fingers. In this embodiment, the gripping range of the fingers is set from a full stretching state to a gripping limit state of the fingers. The gripping limit state of the fingers refers to a state where the fingers grab a cylindrical object with a diameter of 20 mm, and the resistance generated by the bending of the soft actuator 1 does not exceed 1N.

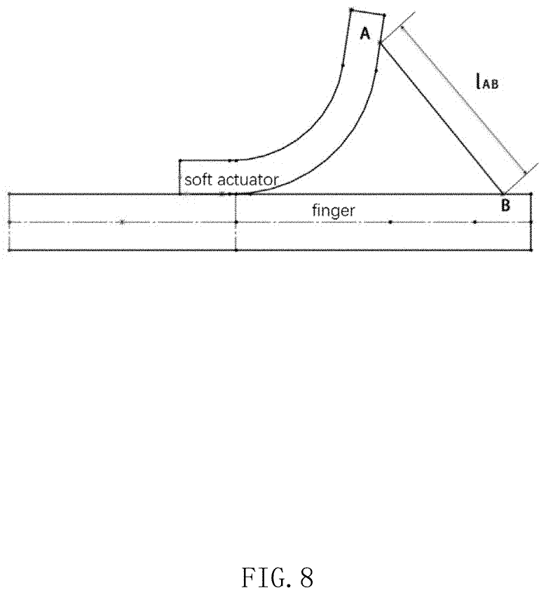

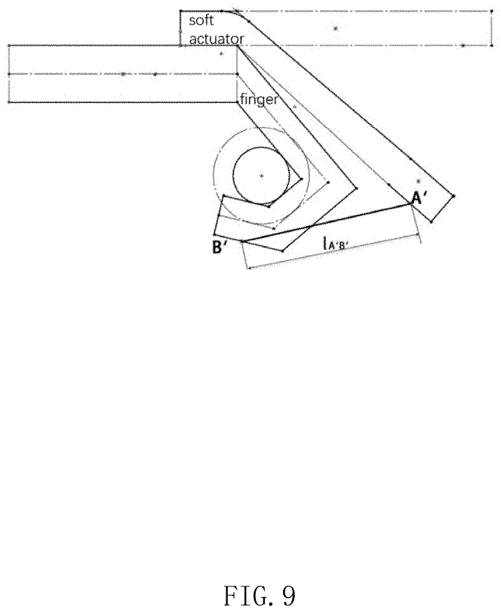

As shown in FIG. 8, the two ends of the rigid connecting rod 8 are respectively connected with the fingertip of the finger and the end of the soft actuator 7. The length of the fingertip and the effective length of the soft actuator have been determined. When the finger is in the stretching state, due to the support of the rigid connecting rod 8, the soft actuator 7 will have an amount of a pre-bending. At this point, the normal bending force of the soft actuator 7 is F, and F is a pushing force relative to the finger; as shown in FIG. 9, when the finger is in the gripping state, the normal bending force of the soft actuator 7 is F′, and F′ is a tensile force relative to the finger. When the two normal bending forces F and F′ of the soft actuator 1 are 1N respectively, the soft actuator has the maximum allowable bending amount, and the lengths of the rigid connecting rod in these two states are the maximum and minimum allowable lengths of the rigid connecting rod. At this point, the position of the connection point between the soft actuator 7 and the rigid connecting rod 8 is A (x_{A}, y_{A}) and A′ (x_{A′}, y_{A′}) respectively, and the position of the connection point between the rigid connecting rod 8 and the fingertip is B (x_{B}, y_{B}) and B′ (x_{B′}, y_{B′}) respectively. The two positions define the range of the bending amount of the soft actuator 7. In the free state, a movement position of the connection point between the rigid connecting rod 8 and the soft actuator 7 must be between A and A′, and a movement position of the connection point between the rigid connecting rod 8 and the fingertip must be between B (x_{B}, y_{B}) and B′ (x_{B′}, y_{B′}).

In order to ensure the lightweight structure of the force feedback glove, the structure of the connecting rod also needs to be simple and lightweight. Therefore, the simplest form is adopted, i.e., a single connecting rod. During the use of the glove, since the connecting rod is rigid, no matter what shape the connecting rod has, a linear length L between both ends of the rigid connecting rod 8 is fixed, and the range of the value of the linear length between both ends of the rigid connecting rod 8 is obtained.

As shown in FIG. 8, in the stretching state of the finger in the free space:

l_{AB}=\sqrt{(x_{A}−x_{B})²−(y_{A}−y_{B})²} L≥l_{AB}

As shown in FIG. 9, in the gripping state of the finger in the free space:

l_{A′B′}=\sqrt{(x_{A′}−x_{B′})²−(y_{A′}−y_{B′})²} L≥l_{A′B′}

The range of the linear length of the rigid connecting rod is thus obtained. After analysis, it is found that the smaller the L is in the gripping state, the larger the deformation of the soft actuator will be, the larger the force generated will be, and the larger the gripping resistance of the palm will be. After inflation, the resistance increases more obviously, which is not advantageous for the optimization of performance in the constrained space. Therefore, L should be as large as possible, and L=l_{AB} is finally chosen.

As shown in FIG. 9, when the user is using the force feedback glove, the rigid connecting rod 8 is prone to interference with the finger during the gripping process. If the rigid connecting rod 8 does not interfere with the finger when the finger is in the gripping limit state (when gripping a cylindrical object with a diameter of 20 mm), it will not interfere with the finger in other states. Therefore, after the length of the rigid connecting rod 8 is determined, the shape of the rigid connecting rod 8 also needs to be determined. However, the use of a rigid structure with angular transition will cause stress concentration, so a smooth curve is preferred adopted for the shape of the rigid connecting rod 8. Therefore, it is necessary to determine a shape curve equation of the rigid connecting rod 8 under the condition that the finger does not interfere with the rigid connecting rod 8 in the gripping limit state of the finger.

An arc is the most common smooth curve. The present disclosure provides a method for determining the curve equation of the arc. In order to calculate the radius R of the arc, the following calculation model is available:

the equation of the arc where the rigid connecting rod is located is:

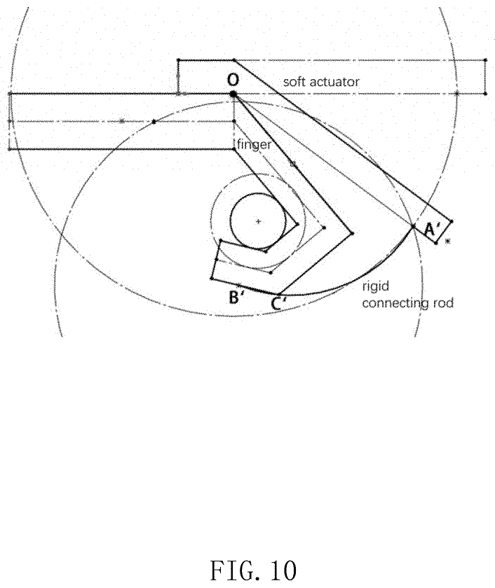

x²+y²+Dx+Ey+F=0(D²+E²−4F>0)

where A′ (x_{A′}, y_{A′}), B′ (x_{B′}, y_{B′}) are the two end points of the rigid connecting rod, which must be on the arc. The length of the rigid connecting rod 2 is L=l_{AB}. The specific position of A′ can be determined by drawing: as shown in FIG. 10, by drawing a circle with B′ as the center and l_{AB} as the radius, and drawing a circle with ∘ as the center and l_{AB} as the radius, the position of A′ can be determined, i.e., intersection points of the two circles.

Considering the structure of the finger, the rigid connecting rod 8 first interferes with the fingertip joint near the end of the finger, which is defined as a point C′ (x_{C′}, y_{C′}). In the critical state, that is, when the rigid connecting rod just interferes with the finger, the point C′ is exactly on the arc where the connecting rod is located. After the three points A′, B′, C′ on the arc are determined, the coordinates of the three points are substituted into the equation where the arc is located, so that the values of three points D, E and F can be obtained. According to the formula below, the radius R of the arc where the connecting rod is located can be obtained, and thus the shape of the connecting rod can be obtained.

$$R = \frac{\sqrt{{D}^{2} + {E}^{2} - 4 F}}{2}$$

In order to ensure a reliable connection between the rigid connecting rod 8 and the fingertip of the finger, a connecting member 9 is provided between the rigid connecting rod 8 and the fingertip of the finger.

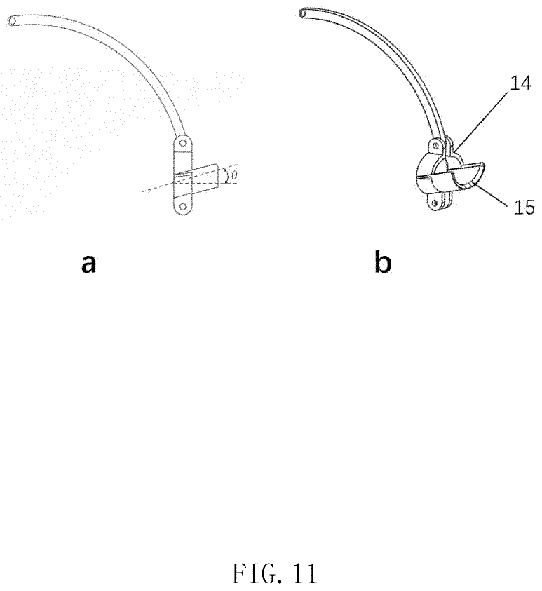

As shown in FIG. 11, the connecting member 9 includes a fingertip sleeve 14 and a fingertip groove 15. The fingertip sleeve 14 tightly clamps the fingertip of the finger, and the fingertip is placed in the fingertip groove 15. There is an included angle θ between an axis of the fingertip sleeve 14 and an axis of the fingertip groove 15, which ensures that there is sufficient comfort and convenience when the fingertip is wearing the connecting member 9. At the same time, the fingertip sleeve 14 of the connecting member 9 is provided with screw holes on both upper and lower sides, and two screws can be adjusted to adapt to the thickness of the fingers of different users.

At the part where the fingertip force feedback unit 1 is connected to the fingertip, a fingertip haptics feedback unit 3 can be provided. In the embodiment in which the above soft actuator is used as the fingertip force actuator, the fingertip haptics feedback unit 3 is provided on a surface of the connecting member 9 that contacts the fingertip.

The fingertip haptics feedback unit 3 is selected from one of a temperature feedback unit, a texture feedback unit or a temperature-texture combined feedback unit. The temperature-texture combined feedback unit includes temperature feedback flakes (such as Peltier patches) and texture feedback flakes, and the texture feedback flakes include a material having large undulations on the surface (such as metal mesh, etc.). The texture feedback flakes and the temperature feedback flakes are encapsulated in a plastic sheath and connected to an air pipe. The temperature of the temperature-texture combined feedback unit can be change by being controlled by electrical signals, and the temperature can be transferred to the fingertip. As for the separate temperature feedback unit or texture feedback unit, only one of the temperature feedback flakes or the texture feedback flakes has to be provided.

The feedback glove is used together with a VR helmet. When people see a virtual object in the helmet and touch and grab it with their hands, the feedback glove adjusts its own state according to the position to be touched and the force feedback, temperature or texture information it should generate, so that the hand touches and feels the haptic feeling similar to the virtual scene.

The embodiments described above are preferred embodiments of the present disclosure, but the embodiments of the present disclosure are not limited by the embodiments described above, and any other changes, modifications, substitutions, combinations and simplifications made without departing from the spirit and principle of the present disclosure should all be taken as equivalent replacements, which are all included within the scope of protection of the present disclosure.

What is claimed is:

1. A multi-modal haptics feedback glove, comprising: finger position tracking units for measuring positions of fingers in space; and movement angle measuring devices for measuring movement angles of individual joints of the fingers; characterized by comprising fingertip force feedback units disposed on a back side of a hand, a fingertip force feedback being provided by fingertip actuators; joint force feedback units disposed at the joints of the fingers, a joint force feedback being provided by variable-stiffness joint actuators; and fingertip haptics feedback units, which are selected from one of a temperature feedback unit, a texture feedback unit or a temperature-texture combined feedback unit, are disposed on a palm side at positions where the fingertip force feedback units are connected to the fingertips, and are configured to provide temperature feedback or texture feedback or simultaneous feedbacks of both temperature and texture of the fingertips.

2. The multi-modal haptics feedback glove according to claim 1, wherein the joint actuator comprises a variable-stiffness sealing structure and an air pipe communicating with an interior of the variable-stiffness sealing structure; the variable-stiffness sealing structure is inflated or deflated through the air pipe, and a stiffness of the joint actuator is controlled by controlling an air pressure inside the variable-stiffness sealing structure.

3. The multi-modal haptics feedback glove according to claim 2, wherein the interior of the variable-stiffness sealing structure comprises multiple layers of flakes, and the multiple layers of flakes are stacked together.

4. The multi-modal haptics feedback glove according to claim 1, wherein the fingertip actuators are soft actuators.

5. The multi-modal haptics feedback glove according to claim 4, wherein the soft actuator can bend and generate an elastic force; one end of the soft actuator is connected to the back of the hand, and the other end of the soft actuator is connected to the fingertip of the finger through a rigid connecting rod, so as to realize transmission of force; in a free space state, within a gripping range of the fingers, a resistance generated by the bending of the soft actuator does not exceed a defined value; and in a constrained space state, the soft actuator is inflated and bent, and the force generated by the soft actuator is transmitted to the finger through the rigid connecting rod, thereby generating a feedback force.

6. The multi-modal haptics feedback glove according to claim 5, wherein a connecting member is further provided between the rigid connecting rod and the fingertip of the finger.

7. The multi-modal haptics feedback glove according to claim 6, wherein the fingertip haptics feedback unit is disposed on a surface of the connecting member that is in contact with the fingertip of the finger.
